(19) United States
(12) Patent Application Publication
(10) Pub. No.: US 2020/0095712 A1
(43) Pub. Date: Mar. 26, 2020

(54) CEILING BOARD AND TILE WITH REDUCED DISCOLORATION

(71) Applicant: Owens Corning Intellectual Capital, LLC, Toledo, OH (US)

(72) Inventors: Gert Mueller, New Albany, OH (US); Xiujuan Zhang, New Albany, OH (US); Andrew Broderick, Newark, OH (US); Loren Birdsall, Pickerington, OH (US)

(21) Appl. No.: 16/578,793

(22) Filed: Sep. 23, 2019

Related U.S. Application Data
(60) Provisional application No. 62/735,424, filed on Sep. 24, 2018.

(51) Int. Cl. D04H 1/4218; D04H 1/587; C08K 5/053; C08L 29/04; C08L 31/04; E04B 1/76; E04B 9/00

(52) U.S. Cl. CPC D04H 1/4218; D04H 1/587; C08K 5/053; C08K 2201/012; C08L 31/04; E04B 1/7658; E04B 9/001; C08L 29/04

(57) ABSTRACT

A fibrous insulation product is provided comprising a nonwoven fiber mat including a plurality of fibers bound together by an aqueous binder composition comprising that includes a thermally degradable polyol; a crosslinking agent; and an acid/aldehyde. The binder composition is free of added formaldehyde.

### CROSS REFERENCE TO RELATED APPLICATIONS

This application claims priority to and the benefit of U.S. Provisional Application No. 62/735,424, filed Sep. 24, 2018, the entire content of which is incorporated by reference herein.

### BACKGROUND

Fibrous insulation and construction panels are typically manufactured by fiberizing a molten composition of polymer, glass, or other mineral material to form fine fibers and depositing the fibers on a collecting conveyor to form a batt or a blanket. Mineral fibers, such as glass fibers or mineral wool, are typically used in insulation products. A binder composition is then applied to bind the fibers together where they contact each other. During the manufacturing process, some insulation products are formed and cut to provide sizes generally dimensioned to be compatible with standard construction practices, e.g. ceiling boards having widths and/or length adapted for specific building practices. Ceiling board products may also incorporate a facing layer or material on at least one of the major surfaces, forming ceiling tiles or panels. In some applications, the facer may be an aesthetic or decorative surface and is often painted.

Ceiling tiles are often used to impart both structural and aesthetic value, while also providing acoustical absorbency and attenuation, to building interiors. Ceiling tiles may be used in areas that require noise control, such as public areas and are also used in residential buildings.

Traditional binder compositions used in the production of fiberglass insulation products include phenol-formaldehyde (PF) based-binder compositions, as well as PF resins extended with urea (PUF resins). “Commercial & Industrial” insulation products, such as ceiling board, duct board, duct wrap, duct liners, and the like have utilized phenol-formaldehyde binder technology for the production of heavy density products that are inexpensive and have acceptable physical and mechanical properties. However, formaldehyde binders emit undesirable emissions during the manufacturing of the fiberglass insulation.

As an alternative to formaldehyde-based binders, certain no-added formaldehyde (“NAF”) or formaldehyde-free formulations have been developed for use as a binder in fiberglass insulation products. One of the challenges to developing suitable alternatives, however, is to identify formulations that have comparable mechanical and physical properties to formaldehyde-based binders, while avoiding undesirable properties, such as discoloration. Challenges often include hot/humid performance, stiffness, bond strength, processability (cutting, sanding, and edge painting), and achieving a light color without yellowing.

For example, ceiling tiles often have at least one scrim adhered thereto, which may be painted with a white (or otherwise colored) paint. It has been found that white painted tiles formed using a NAF or formaldehyde-free binder, when stored, tend to yellow after time. Thus, the panels may not provide a uniform color if tiles from different boards are used.

Additionally, maintaining stiffness and rigidity of ceiling panels under high humidity conditions continue to be a problem for the ceiling tile industry. The problem is acute since the tiles and boards which are used in ceilings are supported only around their perimeters. Humidity weakens the tile and, due to the limited support around the perimeter, the tile unacceptably sags.

Accordingly, there is a need for an environmentally friendly, no-added formaldehyde or formaldehyde-free binder composition for use in the production of insulation products, particularly ceiling tiles, that resists yellowing and discoloration, while maintaining desirable stiffness and rigidity under humidity conditions.

### SUMMARY

Various exemplary embodiments of the present inventive concepts are directed to a fibrous insulation product comprising a non-woven fiber mat comprising a plurality of fibers bound together by an aqueous binder composition comprising a thermally degradable polyol, a cross-linking agent, and an acid/aldehyde scavenger selected from the group consisting of alkali hydroxides; alkaline earth hydroxides; alkali carbonates and alkali bicarbonates; ammonium and/or alkali phosphates; mono-, di-, and poly-primary amines; secondary or tertiary amines; aromatic amines; amides and lactams; and sulfites. The binder composition is free of added formaldehyde.

In some exemplary embodiments, the cross-linking agent comprises a homopolymer or copolymer of acrylic acid and the thermally degradable polyol is selected from the group consisting of polyvinyl alcohol and polyvinyl acetate. In some exemplary embodiments, the thermally degradable polyol may be present in the binder composition in an amount from about 3.0 to 30.0% by weight solids.

In some exemplary embodiments, the aqueous binder composition further includes one or more of a short-chain polyol with a molecular weight less than 1000 Daltons and carbohydrate-based polyol. The carbohydrate-based polyol may comprise a sugar alcohol selected from the group consisting of glycerol, erythritol, arabitol, xylitol, sorbitol, maltitol, mannitol, iditol, isomaltitol, lactitol, cellobitol, palatinitol, maltotritol, syrups thereof and mixtures thereof.

In some exemplary embodiments, the crosslinking agent is present in said binder composition in an amount from about 50 to about 85% by weight solids. In some exemplary embodiments, the acid/aldehyde scavenger is present in said binder composition in an amount from about 0.5 to about 15% by weight total solids.

Various exemplary embodiments of the present inventive concepts are directed to a fibrous insulation product comprising a non-woven fiber mat comprising a plurality of fibers bound together by an aqueous binder composition that includes a thermally degradable polyol, a crosslinking agent, and an organic or inorganic base selected from the group consisting of ammonia, alkyl-substituted amines, dimethyl amine, ethyl methyl amine, sodium hydroxide, potassium hydroxide, sodium carbonate, and t-butylammonium hydroxide. The binder composition is free of added formaldehyde.

In some exemplary embodiments, the cross-linking agent comprises a homopolymer or copolymer of acrylic acid and the thermally degradable polyol is selected from the group consisting of polyvinyl alcohol and polyvinyl acetate. In some exemplary embodiments, the thermally degradable polyol may be present in the binder composition in an amount from about 3.0 to 30.0% by weight solids.

In some exemplary embodiments, the aqueous binder composition further includes one or more of a short-chain polyol with a molecular weight less than 1000 Daltons and carbohydrate-based polyol. The carbohydrate-based polyol may comprise a sugar alcohol selected from the group consisting of glycerol, erythritol, arabitol, xylitol, sorbitol, maltitol, mannitol, iditol, isomaltitol, lactitol, cellobitol, palatinitol, maltotritol, syrups thereof and mixtures thereof.

In some exemplary embodiments, the crosslinking agent is present in said binder composition in an amount from about 50 to about 85% by weight solids. In some exemplary embodiments, the acid/aldehyde scavenger is present in said binder composition in an amount from about 0.5 to about 15% by weight total solids.

In some exemplary embodiments, the pH of the binder composition is from about 2.7 to about 4.7.

Various exemplary embodiments of the present inventive concepts are directed to a ceiling board comprising a nonwoven fiber mat having a first side and a second side, opposite the first side. The nonwoven mat includes a plurality of fibers bound together by at least partially cured aqueous binder composition comprising a thermally degradable polyol and a crosslinking agent. At least one of the first side and second side of the nonwoven mat is at least partially coated with an acid/aldehyde scavenger selected from the group consisting of alkali hydroxides; alkaline earth hydroxides; alkali carbonates and alkali bicarbonates; ammonium and/or alkali phosphates; mono-, di-, and poly-primary amines; secondary or tertiary amines; aromatic amines; amides and lactams; and sulfites.

In some exemplary embodiments, the acid/aldehyde scavenger is in the form of a dry powder. The acid/aldehyde scavenger may be added in an amount up to about 2.0 wt. % solids, based on weight of the ceiling board.

Various exemplary embodiments of the present inventive concepts are directed to a ceiling tile comprising a core that includes a nonwoven fiber mat having a first side and a second side, opposite the first side. The nonwoven fiber includes a plurality of fibers bound together by a formaldehyde-free binder composition and at least one facer adhered to one of the first side and said second side, the facer being white or lightly colored. The formaldehyde-free binder composition comprises a thermally degradable polyol, a cross-linking agent, and an acid scavenger selected from the group consisting of alkali hydroxides; alkaline earth hydroxides; alkali carbonates and alkali bicarbonates; ammonium and/or alkali phosphates; mono-, di-, and poly-primary amines; secondary or tertiary amines; aromatic amines; amides and lactams; and sulfites. The ceiling tile, when exposed to heat, moisture, or aging experiences a 4b* shift of less than 1, as measured using the L*a*b* coordinate system using the CIELAB method.

Various exemplary embodiments of the present inventive concepts are directed to a method for reducing discoloration of ceiling tiles that includes producing a fiberglass insulation board having a first side and a second side, opposite the first side, the fiberglass insulation board comprising a plurality of glass fibers bound together by an aqueous binder composition, at least partially curing the fiberglass insulation board, and adhering a facer to at least one of the first side and the second side. The formaldehyde-free binder composition comprises a thermally degradable polyol, a crosslinking agent, and an acid scavenger selected from the group consisting of alkali hydroxides; alkaline earth hydroxides; alkali carbonates and alkali bicarbonates; ammonium and/or alkali phosphates; mono-, di-, and poly-primary amines; secondary or tertiary amines; aromatic amines; amides and lactams; and sulfites.

Numerous other aspects, advantages, and/or features of the general inventive concepts will become more readily apparent from the following detailed description of exemplary embodiments and from the accompanying drawings being submitted herewith.

### BRIEF DESCRIPTION OF THE DRAWINGS

The general inventive concepts, as well as illustrative embodiments and advantages thereof, are described below in greater detail, by way of example, with reference to the drawings in which:

FIG. 1 graphically illustrates the tensile strengths of nonwoven handsheets over both ambient conditions, as binder pH is increased.

FIG. 2 graphically illustrate the tensile strengths of nonwoven handsheets over hot/humid conditions, as binder pH is increased.

FIG. 3 graphically illustrates the Δb* shifts demonstrated by boards and nonwoven filter sheets formed using binder compositions without the yellow-mitigation solutions disclosed herein.

FIG. 4 graphically illustrates the Δb* shift demonstrated by nonwoven filter sheets prepared using the NAF binder compositions disclosed herein, with varying concentrations of alumina trihydrate (“ATH”) added to the uncured NAF binder composition.

FIG. 5 graphically illustrates the Δb* shift demonstrated by nonwoven filter sheets prepared using various NAF binder compositions.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments. Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” The term “about” means within +/−10% of a value, or in some instances, within +/−5% of a value, and in some instances within +/−1% of a value.

Accordingly, unless indicated to the contrary, the numerical parameters set forth in the specification and attached claims are approximations that may vary depending upon the desired properties sought to be obtained by the present exemplary embodiments. At the very least each numerical parameter should be construed in light of the number of significant digits and ordinary rounding approaches.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein.

The present inventive concepts are directed to fibrous insulation products, such as ceiling board and ceiling tiles formed therefrom, that are generally formed of a collection of fibers bonded together by a cured thermoset polymeric binder material. The fibrous product may comprise inorganic fibers, organic fibers, or a mixture thereof. Examples of suitable inorganic fibers include glass fibers, wool glass fibers, and ceramic fibers. Optionally, other reinforcing fibers such as natural fibers and/or synthetic fibers, such as polyester, polyethylene, polyethylene terephthalate, polypropylene, polyamide, aramid, and/or polyaramid fibers may be present in the insulation product in addition to the inorganic fibers. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include basalt, cotton, jute, bamboo, ramie, bagasse, hemp, coir, linen, kenaf, sisal, flax, henequen, and combinations thereof. Insulation products may be formed entirely of one type of fiber, or they may be formed of a combination of types of fibers. For example, the insulation product may be formed of combinations of various types of glass fibers or various combinations of different inorganic fibers and/or natural fibers depending on the desired application for the insulation.

Although various types of fibrous insulation products and processes for manufacturing such products are known, one example of the manufacture of glass fiber or mineral insulation is carried out in a continuous process by rotary fiberization of molten glass or other mineral material. Blowers then direct the fibers toward a conveyor to form a fibrous pack. The fibers are sprayed with a binder composition and optionally with water, such that the binder composition is essentially evenly distributed throughout the formed insulation pack.

Fibers having the uncured resinous binder adhered thereto may be gathered and formed into an uncured insulation pack and compressed to the desired area weight on a forming conveyor. A vacuum draws air through the fibrous pack from below the forming conveyor, which further compresses the insulation pack. The residual heat from the glass fibers and the flow of air through the fibrous pack during the forming operation are generally sufficient to volatilize a majority of the water from the binder and optional water spray before the glass fibers exit the forming chamber, thereby leaving the remaining components of the binder on the fibers as a viscous or semi-viscous high-solids liquid.

The insulation pack is then directed in its partial compressed condition to the curing oven. It is then compressed to the desired thickness between the top and bottom oven chains while passing through a curing oven at a temperature sufficient to cure the binder to achieve dimensional and mass stability to the plurality of glass fibers constituting the body. The curing oven may be operated at a temperature from about 100° C. to about 325° C., or from about 175° C. to about 300° C. Forced air may be blown through the insulation pack to advance the binder cure and drive off residual moisture or condensation products formed during cure. The insulation pack may remain within the oven for a period of time sufficient to crosslink (cure) the binder and form the insulation board. The insulation board may be cut into predetermined lengths by a cutting device and subsequently stored.

A reinforcement material or scrim may then be adhered to the insulation board to form a ceiling tile. Non-limiting examples of suitable scrim materials include woven or nonwoven fiberglass mats, Kraft paper, a foil-scrim-Kraft paper laminate, recycled paper, and calendared paper. The reinforcement material may be adhered to the surface of the insulation board by any bonding agent or adhesive material conventionally used in the art. Suitable bonding agents include adhesives, polymeric resins, asphalt, and bituminous materials that can be coated or otherwise applied to the reinforcement material.

The insulation products may include heavy density insulation products, including ceiling board and panels, manufactured with a no-added formaldehyde (“NAF”) aqueous binder composition that has comparable or improved mechanical and physical performance, including reduced or no yellowing in downstream applications, compared to products manufactured with traditional NAF or formaldehyde-free binder compositions.

In some exemplary embodiments, the subject NAF aqueous binder composition includes at least one thermally degradable polyol. By “thermally degradable polyol,” it is meant a polyol that degrades at temperatures below 300° C., especially under acidic conditions forming water, volatile carboxylic acid, and/or carbonyl-group containing compounds. Exemplary thermally degradable polyols include polymeric polyhydroxy compounds, such as polyvinyl alcohol, polyvinyl acetate, which may be partially or fully hydrolyzed, or mixtures thereof. Illustratively, when a partially hydrolyzed polyvinyl acetate serves as the polyhydroxy component, an 80%-89% hydrolyzed polyvinyl acetate may be utilized, such as, for example Poval® 385 (Kuraray America, Inc.) and Sevol™ 502 (Sekisui Specialty Chemicals America, LLC), both of which are about 85% (Poval® 385) and 88% (Selvol™ 502) hydrolyzed.

The thermally degradable polyol compound may be present in the aqueous binder composition in an amount up to about 30% by weight total solids, including without limitation, up to about 28%, 25%, 20%, 18%, 15%, and 13% by weight total solids. In some exemplary embodiments, the polymeric polyhydroxy compound is present in the aqueous binder composition in an amount from 3.0% to 30% by weight total solids, including without limitation 5% to 25%, 8% to 20%, 9% to 18%, and 10% to 16%, by weight total solids.

Optionally, the NAF aqueous binder composition may include one or more crosslinking agents. The crosslinking agent may be any compound suitable for crosslinking the polymeric polyhydroxyl compound. In exemplary embodiments, the crosslinking agent has a number average molecular weight greater than 90 Daltons, from about 90 Daltons to about 40,000 Daltons, or from about 1000 Daltons to about 25,000 Daltons, or from about 7,000 to about 23,000 Daltons, or from about 5,000 to about 15,000 Daltons. In some exemplary embodiments, the crosslinking agent has a number average molecular weight of about 2,000 Daltons to 15,000 Daltons, or about 3,000 to 10,000 Daltons. Non-limiting examples of suitable crosslinking agents include materials having one or more carboxylic acid groups (—COOH), such as polycarboxylic acids (and salts thereof), anhydrides, monomeric and polymeric polycarboxylic acid with anhydride (i.e., mixed anhydrides), and homopolymer or copolymer of acrylic acid, such as polyacrylic acid (and salts thereof) and polyacrylic acid based resins such as QR-1629S and Acumer 9932, both commercially available from The Dow Chemical Company. Acumer 9932 is a polyacrylic acid/sodium hypophosphite resin having a molecular weight of about 4000 and a sodium hypophosphite content of 6-7% by weight. QR-1629S is a polyacrylic acid/glycerin mixture. Additional exemplary crosslinking agents include monomeric carboxylic acids, such as maleic acid, citric acid, and the like.

The crosslinking agent may, in some instances, be pre-neutralized with a neutralization agent. Such neutralization agents may include organic and/or inorganic bases, such as sodium hydroxide, ammonium hydroxide, and diethylamine, and any kind of primary, secondary, or tertiary amine (including alkanol amine). In various exemplary embodiments, the neutralization agents may include at least one of sodium hydroxide and triethanolamine.

In some exemplary embodiments, if included, the crosslinking agent is present in the aqueous binder composition in at least 50 wt. %, based on the total solids content of the aqueous binder composition, including, without limitation at least 55 wt. %, at least 60 wt. %, at least 63 wt. %, at least 65 wt. %, at least 70 wt. %, at least 73 wt. %, at least 75 wt. %, at least 78 wt. %, and at least 80 wt. %. In some exemplary embodiments, the primary crosslinking agent is present in the aqueous binder composition in an amount from about 50% to about 85% by weight, based on the total solids content of the aqueous binder composition, including without limitation about 60% to about 80% by weight, about 62% to about 78% by weight, and about 65% to about 75% by weight.

The NAF aqueous binder composition may further include a short-chain polyol with a molecular weight less than 1000 Daltons or a carbohydrate-based polyol, such as a sugar alcohol. Sugar alcohols are understood to mean compounds obtained when the aldo or keto groups of a sugar are reduced (e.g. by hydrogenation) to the corresponding hydroxy groups. The starting sugar might be chosen from monosaccharides, oligosaccharides, and polysaccharides, and mixtures of those products, such as syrups, molasses and starch hydrolyzates. The starting sugar also could be a dehydrated form of a sugar. Although sugar alcohols closely resemble the corresponding starting sugars, they are not sugars. Thus, for instance, sugar alcohols have no reducing ability, and cannot participate in the Maillard reaction typical of reducing sugars. In some exemplary embodiments, the sugar alcohol includes glycerol, erythritol, arabitol, xylitol, sorbitol, maltitol, mannitol, iditol, isomaltitol, lactitol, cellobitol, palatinitol, maltotritol, isosorbide, syrups thereof and mixtures thereof. In various exemplary embodiments, the sugar alcohol is selected from glycerol, sorbitol, xylitol, and mixtures thereof. In some exemplary embodiments, the sugar alcohol is a diol or glycol.

In some exemplary embodiments, the carbohydrate-based polyol is present in the aqueous binder composition in an amount up to about 30% by weight total solids, including without limitation, up to about 25%, 20%, 18%, 15%, 13%, 11%, and 10% by weight total solids. In some exemplary embodiments, the short-chain polyol is present in the aqueous binder composition in an amount from 0 to 30% by weight total solids, including without limitation 2% to 30%, 3% to 25%, 5% to 20%, 8% to 18%, and 9% to 15%, by weight total solids.

Either in-line with the manufacturing process of the insulation board or in a secondary step, a reinforcement material or scrim may be adhered to the insulation board to form a ceiling tile. Non-limiting examples of suitable scrim materials include woven or nonwoven fiberglass mats, surfacing veils or mats of fiberglass or polyester or mixture of fiberglass and polyester, tissues of glass fibers, synthetic fibers, or a combination of glass and synthetic fibers, Kraft paper, a foil-scrim-Kraft paper laminate, recycled paper, calendared paper, cloth, and felt. Exemplary surfacing veils include dry-laid or wet-laid glass surfacing veils and surfacing veils with randomly dispersed polymeric or blended glass and polymeric fibers. Polymeric fibers include polyester and polyamide or polyolefinic fibers. Synthetic fibers can include polyester, polyamide, aramid, polyolefinic or carbon fibers. The reinforcement material may be adhered to the surface of the insulation board by any bonding agent or adhesive material conventionally used in the art. Suitable bonding agents include adhesives, adhesive emulsions, polymeric resins, asphalt, and bituminous materials that can be coated or otherwise applied to the reinforcement material.

The reinforcing material or scrim which is adhered to the insulation board is painted and dried in a subsequent step. Typically, a latex paint is used. In non-limiting examples, the latex paint has a white color.

It has been found that high-density insulation products, such as ceiling tiles, manufactured using some formaldehyde-free or NAF binder compositions experience yellowing and/or discoloration when a scrim is adhered to the ceiling board and the resulting ceiling tile is exposed to heat or stored. Although not intending to be bound by theory, it is believed that as the insulation board or manufactured ceiling tile is exposed to heat during curing, drying or storage, the thermally degradable polyol compound begins to degrade and off-gas emissions that reacts with the painted scrim and causes a yellowing discoloration. It has been discovered that various factors lead to the thermally degradable compound degradation, including cure temperature, cure time, and binder pH.

In some exemplary embodiments, the insulation product has a density between about 1.5 and 10 pounds per cubic feet (pcf). In some exemplary embodiments, the insulation product has a density between about 2 and about 9 pcf, including between about 2.8 and 8.5 pcf, and between about 2.5 and 7 pcf.

Thus, there are several yellow-mitigation solutions that have been surprisingly discovered to control the yellowing and/or discoloration of such insulation products. One such yellow-mitigation solution includes controlling the NAF binder composition pH, which stabilizes the thermally degradable compound and reduces or eliminates the discoloration of the resulting ceiling tile. Although the binder composition needs an acidic environment to cure, it has been discovered that the pH of the binder composition can be increased to a certain extent to reduce downstream degradation of the polyol without affecting performance properties of the board. The increase in pH slows the reaction rate of dehydration of the polyol susceptible to rearrangements and formation of carbonyl and acid-catalyzed oxidative decomposition reactions, which lead to formation of volatile organic compounds, potentially with acidic or carbonyl functionality, resulting in yellowing of the paint.

In some exemplary embodiments, pH control of the NAF binder composition occurs by the addition of an acid and/or aldehyde scavenger to the uncured binder composition. Exemplary acid/aldehyde scavengers include alkali hydroxides, including sodium hydroxide (NaOH), potassium hydroxide (KOH), lithium hydroxide (LiOH); alkaline earth hydroxides, including calcium hydroxide (Ca(OH)₂) and magnesium hydroxide (Mg(OH)₂); alkali carbonates and alkali bicarbonates, such as Na₂CO₃, K₂CO₃, NaHCO₃, and KHCO₃; and/or alkali phosphates, such as Na₃PO₄, Na₂HPO₄, mono-, di-, and poly-primary amines, such as butylamine, hexamethylenediamine, Jeffamine T-403, 1,3-Bis(aminomethyl)benzene, tetraethylene pentaamine; secondary or tertiary amines, such as diethanolamine and triethanolamine; aromatic amines, such as benzamides, including 2-amino-benzamide; amides and lactams, such a propionamide, caprolactam, malonamide, and saliyclamide; aluminum hydroxy carbonate and alumina trihydrate; and sulfites. In some exemplary embodiments, the aldehyde scavenger comprises an alkali hydroxide or 2-amino-benzamide.

In some exemplary embodiments, the acid/aldehyde scavenger is present in the NAF aqueous binder composition in an amount up to about 15% by weight total solids, including without limitation, from about 0.5% to about 15% by weight total solids; from about 1% to about 10% by weight total solids; from about 1.5% to about 5% by weight total solids.

In some exemplary embodiments, pH control of the NAF binder composition occurs by the addition of organic and/or inorganic bases in the binder composition to increase the pH of the binder. In some exemplary embodiments, the bases may be a volatile or non-volatile base. Exemplary volatile bases include, for example, ammonia and alkyl-substituted amines, such as methyl amine, ethyl amine or 1-aminopropane, dimethyl amine, and ethyl methyl amine. Exemplary non-volatile bases include, for example, sodium hydroxide, potassium hydroxide, sodium carbonate, and t-butylammonium hydroxide.

In some exemplary embodiments, pH control of the NAF binder composition occurs by the addition of a mixture of an acid/aldehyde scavenger and an organic and/or inorganic base.

In certain exemplary embodiments, pH control of the NAF binder composition may occur by adjusting the pH of the binder composition to a more acidic pH. Examples of suitable acidic pH adjusters include inorganic acids and salts thereof, such as, for example, sulfuric acid, phosphoric acid and boric acid and also organic acids and salts thereof, such as, for example, p-toluenesulfonic acid, mono- or polycarboxylic acids, such as, but not limited to, citric acid, acetic acid and anhydrides thereof, adipic acid, oxalic acid, and their corresponding salts, or polymeric polycarboxylic acids, such as polyacrylic acid.

In some exemplary embodiments, the base is present in the NAF aqueous binder composition in an amount up to about 17% by weight total solids, including without limitation, from about 0.5% to about 15% by weight total solids; from about 1% to about 10% by weight total solids; from about 1.5% to about 5% by weight total solids.

The pH of the binder composition cures under acidic conditions and has a natural, uncured pH between about 2.0-5.0, including all amounts and ranges in between. The pH control discussed above increases the pH (within the natural pH of about 2 to 5) about 0.5-2.5 pH units, or between about 0.5-1.5 pH units. Thus, if the natural, uncured pH of the binder composition (prior to addition of a pH control agent) is, for example, 2.2, the pH of the binder composition may be adjusted to a pH of about 2.7 to about 4.7. In some exemplary embodiments, the pH of the binder composition, when in an un-cured state, is about 2.2-4.0, including about 2.5-3.8, and about 2.6-3.5. After cure, the pH of the binder composition may rise to at least a pH of 6.0, including levels between about 6.5 and 7.2, or between about 6.8 and 7.2.

Another yellow-mitigation solution includes the addition of acid/aldehyde scavenger materials onto a cured ceiling board product, prior to the application of a scrim or other facing materials to the board. This technique may be used in lieu of, or in addition to the addition of acid/aldehyde scavengers or pH adjusters to the uncured binder composition.

As mentioned above, exemplary acid/aldehyde scavengers include alkali hydroxides, including sodium hydroxide (NaOH), potassium hydroxide (KOH), lithium hydroxide (LiOH); alkaline earth hydroxides, including calcium hydroxide (Ca(OH)₂) and magnesium hydroxide (Mg(OH)₂); alkali carbonates and alkali bicarbonates, such as Na₂CO₃, K₂CO₃, NaHCO₃, and KHCO₃; ammonium and/or alkali phosphates, such as Na₃PO₄, Na₂HPO₄, (NH₄)₂HPO₄, and (NH₄)₃PO₄); mono-, di-, and poly-primary amines, such as butylamine, hexamethylenediamine, Jeffamine T-403, 1,3-Bis(aminomethyl)benzene, tetraethylene pentaamine; secondary or tertiary amines, such as diethanolamine and triethanolamine; aromatic amines, such as benzamides, including 2-amino-benzamide; amides and lactams, such a propionamide, caprolactam, malonamide, and saliyclamide; aluminum hydroxy carbonate and alumina trihydrate; and sulfites. In some exemplary embodiments, the scavenger applied onto the cured ceiling board include alkali or ammonium hydroxides, alkali or ammonium carbonates, or alkali or ammonium bicarbonates.

In some exemplary embodiments, the acid/aldehyde scavenger is added onto a cured ceiling board product by any known application means, including application of a dry powder by dusting the surface of the board, application of a solution comprising the acid/aldehyde scavenger as a coating on the surface of the board, and application by curtain or spray coating of solutions or dispersions (liquid pressure or air pressure). In some exemplary embodiments, the acid/aldehyde scavenger coated is added in an amount up to about 5% by weight total solids, including from about 0.05 to about 2% by weight total solids, and about 0.1-1% by weight total solids, based on the total weight of the ceiling board.

Optionally, the aqueous binder composition may include an esterification catalyst, also known as a cure accelerator. The catalyst may include inorganic salts, Lewis acids (i.e., aluminum chloride or boron trifluoride), Bronsted acids (i.e., sulfuric acid, p-toluenesulfonic acid and boric acid) organometallic complexes (i.e., lithium carboxylates, sodium carboxylates), and/or Lewis bases (i.e., polyethyleneimine, diethylamine, or triethylamine). Additionally, the catalyst may include an alkali metal salt of a phosphorous-containing organic acid; in particular, alkali metal salts of phosphorus acid, hypophosphorus acid, or polyphosphoric. Examples of such phosphorus catalysts include, but are not limited to, sodium hypophosphite, sodium phosphate, potassium phosphate, disodium pyrophosphate, tetrasodium pyrophosphate, sodium tripolyphosphate, sodium hexametaphosphate, potassium phosphate, potassium tripolyphosphate, sodium trimetaphosphate, sodium tetrametaphosphate, and mixtures thereof. In addition, the catalyst or cure accelerator may be a fluoroborate compound such as fluoroboric acid, sodium tetrafluoroborate, potassium tetrafluoroborate, calcium tetrafluoroborate, magnesium tetrafluoroborate, zinc tetrafluoroborate, ammonium tetrafluoroborate, and mixtures thereof. Further, the catalyst may be a mixture of phosphorus and fluoroborate compounds. Other sodium salts such as, sodium sulfate, sodium nitrate, sodium carbonate may also or alternatively be used as the catalyst.

The catalyst may be present in the aqueous binder composition in an amount from about 0% to about 10% by weight of the total solids in the binder composition, including without limitation, amounts from about 1% to about 5% by weight, or from about 2% to about 4.5% by weight, or from about 2.8% to about 4.0% by weight, or from about 3.0% to about 3.8% by weight.

Optionally, the aqueous binder composition may contain at least one coupling agent. In at least one exemplary embodiment, the coupling agent is a silane coupling agent. The coupling agent(s) may be present in the binder composition in an amount from about 0.01% to about 5% by weight of the total solids in the binder composition, from about 0.01% to about 2.5% by weight, from about 0.05% to about 1.5% by weight, or from about 0.1% to about 1.0% by weight.

Non-limiting examples of silane coupling agents that may be used in the binder composition may be characterized by the functional groups alkyl, aryl, amino, epoxy, vinyl, methacryloxy, ureido, isocyanato, and mercapto. In exemplary embodiments, the silane coupling agent(s) include silanes containing one or more nitrogen atoms that have one or more functional groups such as amine (primary, secondary, tertiary, and quaternary), amino, imino, amido, imido, ureido, or isocyanato. Specific, non-limiting examples of suitable silane coupling agents include, but are not limited to, aminosilanes (e.g., triethoxyaminopropylsilane; 3-aminopropyl-triethoxysilane and 3-aminopropyl-trihydroxysilane), epoxy trialkoxysilanes (e.g., 3-glycidoxypropyltrimethoxysilane and 3-glycidoxypropyltriethoxysilane), methyacryl trialkoxysilanes (e.g., 3-methacryloxypropyltrimethoxysilane and 3-methacryloxypropyltriethoxysilane), hydrocarbon trialkoxysilanes, amino trihydroxysilanes, epoxy trihydroxysilanes, methacryl trihydroxy silanes, and/or hydrocarbon trihydroxysilanes. In one or more exemplary embodiment, the silane is an aminosilane, such as γ-aminopropyltriethoxysilane.

Optionally, the aqueous binder composition may include a process aid. The process aid is not particularly limiting so long as the process aid functions to facilitate the processing of the fibers formation and orientation. The process aid can be used to improve binder application distribution uniformity, to reduce binder viscosity, to increase ramp height after forming, to improve the vertical weight distribution uniformity, and/or to accelerate binder de-watering in both forming and oven curing process. The process aid may be present in the binder composition in an amount from 0 to about 10% by weight, from about 0.1% to about 5.0% by weight, or from about 0.3% to about 2.0% by weight, or from about 0.5% to 1.0% by weight, based on the total solids content in the binder composition. In some exemplary embodiments, the aqueous binder composition is substantially or completely free of any processing aids.

Examples of processing aids include defoaming agents, such as, emulsions and/or dispersions of mineral, paraffin, or vegetable oils; dispersions of polydimethylsiloxane (PDMS) fluids, and silica which has been hydrophobized with polydimethylsiloxane or other materials. Further processing aids may include particles made of amide waxes such as ethylenebis-stearamide (EBS) or hydrophobized silica. A further process aid that may be utilized in the binder composition is a surfactant. One or more surfactants may be included in the binder composition to assist in binder atomization, wetting, and interfacial adhesion.

The surfactant is not particularly limited, and includes surfactants such as, but not limited to, ionic surfactants (e.g., sulfate, sulfonate, phosphate, and carboxylate); sulfates (e.g., alkyl sulfates, ammonium lauryl sulfate, sodium lauryl sulfate (SDS), alkyl ether sulfates, sodium laureth sulfate, and sodium myreth sulfate); amphoteric surfactants (e.g., alkylbetaines such as lauryl-betaine); sulfonates (e.g., dioctyl sodium sulfosuccinate, perfluorooctanesulfonate, perfluorobutanesulfonate, and alkyl benzene sulfonates); phosphates (e.g., alkyl aryl ether phosphate and alkyl ether phosphate); carboxylates (e.g., alkyl carboxylates, fatty acid salts (soaps), sodium stearate, sodium lauroyl sarcosinate, carboxylate fluorosurfactants, perfluoronanoate, and perfluorooctanoate); cationic (e.g., alkylamine salts such as laurylamine acetate); pH dependent surfactants (primary, secondary or tertiary amines); permanently charged quaternary ammonium cations (e.g., alkyltrimethylammonium salts, cetyl trimethylammonium bromide, cetyl trimethylammonium chloride, cetylpyridinium chloride, and benzethonium chloride); and zwitterionic surfactants, quaternary ammonium salts (e.g., lauryl trimethyl ammonium chloride and alkyl benzyl dimethylammonium chloride), and polyoxyethylenealkylamines.

Suitable nonionic surfactants that can be used in conjunction with the binder composition include polyethers (e.g., ethylene oxide and propylene oxide condensates, which include straight and branched chain alkyl and alkaryl polyethylene glycol and polypropylene glycol ethers and thioethers); alkylphenoxypoly(ethyleneoxy)ethanols having alkyl groups containing from about 7 to about 18 carbon atoms and having from about 4 to about 240 ethyleneoxy units (e.g., heptylphenoxypoly(ethyleneoxy) ethanol s, and nonylphenoxypoly(ethyleneoxy) ethanol s); polyoxyalkylene derivatives of hexitol including sorbitans, sorbides, mannitans, and mannides; partial long-chain fatty acids esters (e.g., polyoxyalkylene derivatives of sorbitan monolaurate, sorbitan monopalmitate, sorbitan monostearate, sorbitan tristearate, sorbitan monooleate, and sorbitan trioleate); condensates of ethylene oxide with a hydrophobic base, the base being formed by condensing propylene oxide with propylene glycol; sulfur containing condensates (e.g., those condensates prepared by condensing ethylene oxide with higher alkyl mercaptans, such as nonyl, dodecyl, or tetradecyl mercaptan, or with alkylthiophenols where the alkyl group contains from about 6 to about 15 carbon atoms); ethylene oxide derivatives of long-chain carboxylic acids (e.g., lauric, myristic, palmitic, and oleic acids, such as tall oil fatty acids); ethylene oxide derivatives of long-chain alcohols (e.g., octyl, decyl, lauryl, or cetyl alcohols); and ethylene oxide/propylene oxide copolymers.

In at least one exemplary embodiment, the surfactants include one or more of Dynol 607, which is a 2,5,8,11-tetramethyl-6-dodecyne-5,8-diol, Surfynol® 420, Surfynol® 440, and Surfynol® 465, which are ethoxylated 2,4,7,9-tetramethyl-5-decyn-4,7-diol surfactants (commercially available from Evonik Corporation (Allentown, Pa.)), Stanfax (a sodium lauryl sulfate), Surfynol 465 (an ethoxylated 2,4,7,9-tetramethyl 5 decyn-4,7-diol), Triton™ GR-PG70 (1,4-bis(2-ethylhexyl) sodium sulfosuccinate), and Triton™ CF-10 (poly(oxy-1,2-ethanediyl), alpha-(phenylmethyl)-omega-(1,1,3,3-tetramethylbutyl)phenoxy).

Optionally, the binder may contain a dust suppressing agent to reduce or eliminate the presence of inorganic and/or organic particles which may have adverse impact in the subsequent fabrication and installation of the insulation materials. The dust suppressing agent can be any conventional mineral oil, mineral oil emulsion, natural or synthetic oil, bio-based oil, or lubricant, such as, but not limited to, silicone and silicone emulsions, polyethylene glycol, as well as any petroleum or non-petroleum oil with a high flash point to minimize the evaporation of the oil inside the oven.

In some exemplary embodiments, the aqueous binder composition includes up to about 10 wt. % of a dust suppressing agent, including up to about 8 wt. %, or up to about 6 wt. %. In various exemplary embodiments, the aqueous binder composition includes between 0 wt. % and 10 wt. % of a dust suppressing agent, including about 1.0 wt. % to about 7.0 wt. %, or about 1.5 wt. % to about 6.5 wt. %, or about 2.0 wt. % to about 6.0 wt. %, or about 2.5 wt. % to 5.8 wt. %.

The binder further includes water to dissolve or disperse the active solids for application onto the reinforcement fibers. Water may be added in an amount sufficient to dilute the aqueous binder composition to a viscosity that is suitable for its application to the reinforcement fibers and to achieve a desired solids content on the fibers. It has been discovered that the present binder composition may contain a lower solids content than traditional phenol-urea formaldehyde or carbohydrate-based binder compositions. In particular, the binder composition may comprise about 3% to about 35% by weight of binder solids, including without limitation, about 5% to about 25%, about 8% to about 20%, and about 10% to about 19% by weight of binder solids. The binder solids content may be measured based on drying. The binder content in the resulting board product may be measured as loss on ignition (LOI). In certain embodiments, LOI is 3% to 20%, including without limitation, 5% to 17%, 8% to 15%, and 10% to 14.5%.

In some exemplary embodiments, the aqueous binder composition may also include one or more additives, such as a coupling agent, an extender, a crosslinking density enhancer, a deodorant, an antioxidant, a dust suppressing agent, a biocide, a moisture resistant agent, or combinations thereof. Optionally, the binder may comprise, without limitation, dyes, pigments, additional fillers, colorants, UV stabilizers, thermal stabilizers, anti-foaming agents, emulsifiers, preservatives (e.g., sodium benzoate), corrosion inhibitors, and mixtures thereof. Other additives may be added to the binder composition for the improvement of process and product performance. Such additives include lubricants, wetting agents, antistatic agents, and/or water repellent agents. Additives may be present in the binder composition from trace amounts (such as <about 0.1% by weight the binder composition) up to about 10% by weight of the total solids in the binder composition.

The yellow-mitigation solutions disclosed herein reduce the color shift (4b*) in a white or lightly colored painted tile formed using a NAF or formaldehyde-free binder compositions that include thermally degradable polyol compounds that may begin to degrade and off-gas emissions that react with a painted scrim and cause a yellowing discoloration. In some exemplary embodiments, the yellow-mitigation solutions provided herein eliminate any significant change in the b* of the painted tiles. In further exemplary embodiments, the 4b* shift is less than 0.6, or less than 0.4, or less than 0.3. In some exemplary embodiments, the 4b* shift is no more than 0.2.

Another benefit of the yellow-reducing solutions presented herein is that the solutions do not negatively impact the mechanical properties of the resulting ceiling tiles. For instance, after exposure to hot/humid conditions (60 min @ 227° F./100% rH), the tensile/LOI of hand-made nonwoven mats or sheets is at least 0.8 lbf.

Having generally described this invention, a further understanding can be obtained by reference to certain specific examples illustrated below which are provided for purposes of illustration only and are not intended to be all inclusive or limiting unless otherwise specified.

### Example 1

A base NAF binder composition (NAF Binder 1) was produced comprising the following ingredients, listed below in parts by weight, with a solids concentration of 12%:

TABLE 1

| | parts by wt (d.s.b.) |
|---|---|
| Polyacrylic Acid | 75 |
| Sorbitol | 10 |
| Polyvinylalcohol | 15 |
| Sodium Hypophosphite | 3.5 |
| Surfactant | 0.75 |
| Amino-Silane | 0.186 |

The NAF Binder 1 had a starting pH of 2.6 and 5N sodium hydroxide was then added to increase the binder pH by 0.5, 1.0, and 1.5 units. Handsheets were prepared according to the following procedure: First water is added to a bucket (approximately 5 liters). To this water, 8 drops of a dispersant, Nalco 01NM 159 was added. A pneumatic stirrer was lowered into the bucket and set at a slow speed so as to stir but not produce foam. To this stirring mixture, wet chop glass fibers (8 grams) were added and allowed to stir for 5 minutes. A screen catch was placed in a 12×12×12 inch 40 liter Williams standard pulp testing apparatus (a.k.a. a deckle box) and the box was closed. The deckle box was then filled with water to the “3” mark and a plate stirrer was placed in the deckle box. To the water in the deckle box, a 0.5% wt. solution of polyacrylamide, NALCLEAR® 7768, commercially available from the Nalco Company, (80 grams) was added and mixed until dissolved using the plate stirrer. After the glass fiber water had stirred for 5 minutes, a 0.5% wt. solution of polyacrylamide, NALCLEAR® 7768 (80 grams) was added and stirred at low speed for one minute, after which the stirring speed was set to the highest setting and allowed to stir for an additional 2 minutes. The glass fiber solution is then immediately dumped into the deckle box and stirred with the plate stirrer for 10 rapid strokes. At this point, the valve on the deckle box was depressed until the deckle box was empty. After the deckle box was drained, the box was opened and the screen with the handsheet was removed from the base by holding opposite corners of the screen. The screen was then placed on a wooden frame and the NAF binder composition was applied to the handsheet using a roll coater. Excess binder was then vacuumed off. The binder-coated handsheet was placed into an oven for curing at 425° F. for 3.5 minutes and then cut into 1-inch strips. The handsheets had an LOI of about 7.5% to 9.5% and were cut into 1-inch wide strips. The 1-inch wide strips were tested for tensile strength at ambient conditions and after conditioning under hot/humid (autoclave) conditions at 227° F. at 100% relative humidity for 60 minutes. The results are provided below in Table 2.

TABLE 2

| | |
|---|---|
| Binder | Tensile/LOI [lbf] |

Ambient

| | |
|---|---|
| Binder - natural pH | 1.591 |
| Binder - pH +0.5 | 2.165 |
| Binder - pH +1.0 | 2.425 |
| Binder - pH +1.5 | 2.520 |

Hot/Humid Conditioning (60 min @ 227° F./100% rH)

| | |
|---|---|
| Binder - natural pH | 1.120 |
| Binder - pH +0.5 | 1.260 |
| Binder - pH +1.0 | 1.104 |
| Binder - pH +1.5 | 0.908 |

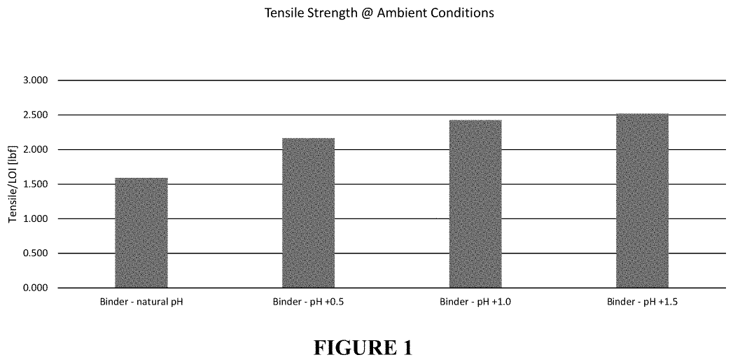

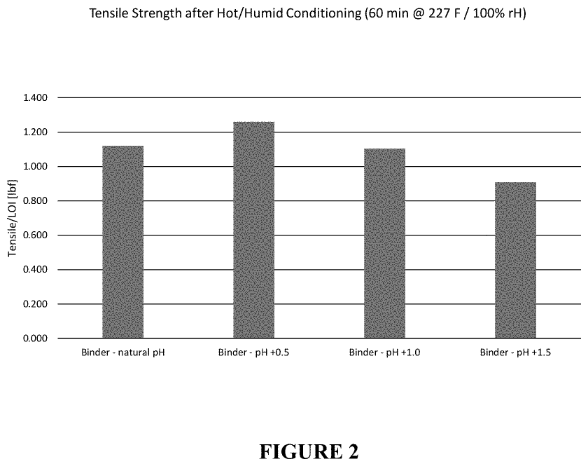

FIGS. 1 and 2 graphically illustrate the tensile strengths of the handsheets over both ambient and hot/humid conditions, as the binder pH was increased. Under ambient conditions, the tensile strengths of the handsheets increased as the pH of the binder composition was increased up to 1.5 pH units. Additionally, under hot/humid conditions, the tensile strengths of the handsheets did not significantly decrease as the pH of the binder composition was increased. A tensile/LOI of 0.908 lbf is acceptable under these conditions.

### Example 2

Nonwoven filter sheets (10 cm×10 cm square sample pads) impregnated with various binder compositions were prepared, cured for a standard 425° F. for 210 seconds, cooled to room temperature, and then cut into 2.25″×2.25″ squares. The targeted LOI of the filter sheets after cure was about 25% to 30%. The binder compositions included: 1) Phenol Urea formaldehyde (PUF Binder); 2) NAF Binder 1 (set forth above in Example 1); and 3) Maltodextrin+Polyacrylic acid+Glycerol+Citric Acid-based (NAF Binder 2). A scrim was harvested from a newly manufactured ceiling tile that was made from an insulation board formed with a phenol urea formaldehyde binder with a white painted scrim, freed from board fibers, and cut into squares with the dimension of 2.25″×2.25″. The scrim squares were measured for color using the CIELAB method. The CIELAB is a color space defined by the International Commission on Illumination (CIE). The color space uses L*a*b* coordinates, wherein L* indicates lightness, a* is the red/green coordinate, and b* is the yellow/blue coordinate. A lower number on this scale indicates less yellowing.

Five of the filter sheets and one scrim square were then stacked in ajar containing 1 mL of water, with an air gap between each filter sheet. The jar was sealed and exposed to 140° F. for a period of 24 hours. The scrim was then removed and measured for color (L*a*b*) a second time.

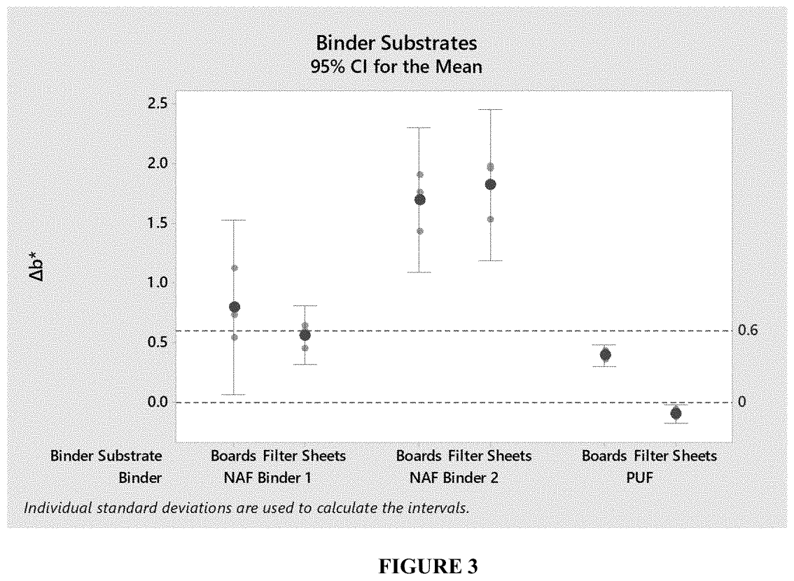

This test method was then repeated, using samples of ceiling board formed using the same binder compositions as previously used (PUF-Binder, NAF Binder 1, and NAF Binder 2). None of the samples included any of the anti-yellowing solutions proposed herein. The testing of the board was conducted in a comparable set-up as the hand sheets. Instead of 5 binder impregnated hand sheet pieces with the dimension of 2.25″×2.25″, one piece of board sample with the dimension of 2.25″×2.25″ (full thickness and without any facings attached) was used as test specimen. As illustrated in FIG. 3, the scrims paired with boards having PVOH (NAF Binder 1) and MD-based binder compositions (NAF Binder 2) demonstrated an increased Δb* shift compared to boards having a PUF-based binder.

Thus, it is clear that a yellowing of the scrim is taking place as the non-formaldehyde-based boards are stored.

### Example 3

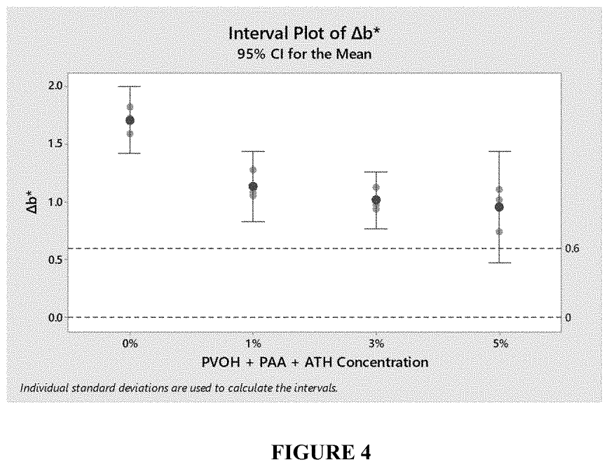

Nonwoven filter sheets (2.25″×2.25″) were prepared using the NAF binder compositions disclosed herein, with varying concentrations of alumina trihydrate (“ATH”) added to the uncured NAF binder composition. The filter sheets were cured for a standard 425° F. for 210 seconds. As illustrated in FIG. 4, the Δb* was the highest at between about 1.5 and 2.0 when the ATH was excluded from the composition. However, as the concentration of ATH increased between 1 wt. % and 5 wt. %, the Δb* levels lowered to below 1.5, and at ATH concentrations of 5.0 wt. %, the Δb* reached less than 1, meaning that yellowing decreased significantly.

### Example 4

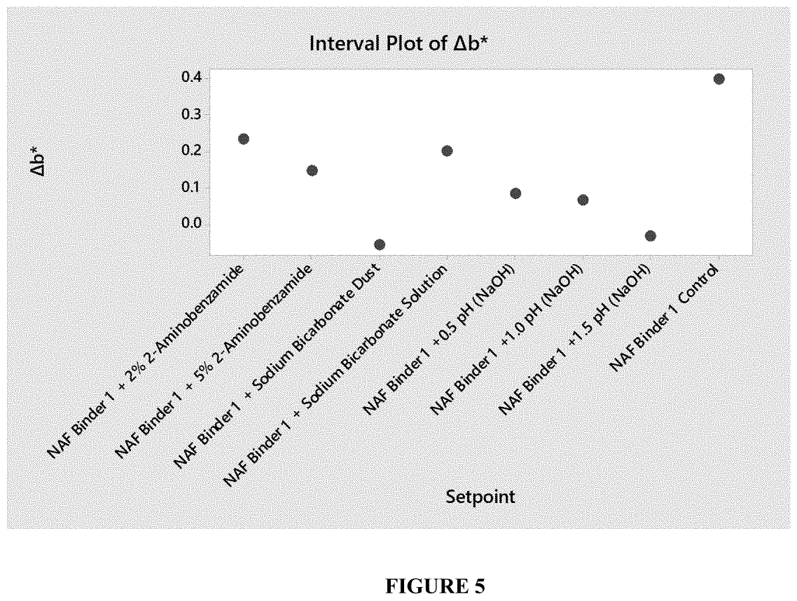

Nonwoven filter sheets (2.25″×2.25″) impregnated with various binder compositions with varying yellowing mitigation solutions were prepared and cured for a standard 425° F. for 210 seconds. The solutions included adding NaOH to the binder compositions to increase the pH by varying amounts, adding 2-aminobenzamide to the binder formulation, and adding sodium bicarbonate (both solids and in solution) onto a cured binder impregnated non-woven. As illustrated in FIG. 5, the Δb* was the highest (about 0.4) for the control, which does not include any yellowing mitigation solution. However, each yellow-mitigation solution lowered the Δb* shift to at least about 0.2 and in some instances eliminated any Δb* all together.

It will be appreciated that many more detailed aspects of the illustrated products and processes are in large measure, known in the art, and these aspects have been omitted for purposes of concisely presenting the general inventive concepts. Although the present invention has been described with reference to particular means, materials and embodiments, from the foregoing description, one skilled in the art can easily ascertain the essential characteristics of the present disclosure and various changes and modifications can be made to adapt the various uses and characteristics without departing from the spirit and scope of the present invention as described above and set forth in the attached claims.

What is claimed is:

1. A fibrous insulation product comprising:
a nonwoven fiber mat comprising a plurality of fibers bound together by an aqueous binder composition comprising:
a thermally degradable polyol;
a crosslinking agent; and
an acid/aldehyde scavenger selected from the group consisting of alkali hydroxides;
alkaline earth hydroxides; alkali carbonates and alkali bicarbonates; ammonium and/or alkali phosphates; mono-, di-, and poly-primary amines; secondary or tertiary amines; aromatic amines; amides and lactams; and sulfites, wherein said binder composition is free of added formaldehyde.

2. The fibrous insulation product of claim 1, wherein said crosslinking agent comprises a homopolymer or copolymer of acrylic acid.

3. The fibrous insulation product of claim 1, wherein said thermally degradable polyol is selected from the group consisting of polyvinyl alcohol and polyvinyl acetate.

4. The fibrous insulation product of claim 1, wherein said thermally degradable polyol is present in said binder composition in an amount from about 3.0 to 30.0% by weight solids.

5. The fibrous insulation product of claim 1, wherein said aqueous binder composition further includes one or more of a short-chain polyol with a molecular weight less than 1000 Daltons and carbohydrate-based polyol.

6. The fibrous insulation product of claim 5, wherein said carbohydrate-based polyol comprises a sugar alcohol selected from the group consisting of glycerol, erythritol, arabitol, xylitol, sorbitol, maltitol, mannitol, iditol, isomaltitol, lactitol, cellobitol, palatinitol, maltotritol, isosorbide, syrups thereof and mixtures thereof.

7. The fibrous insulation product of claim 1, wherein said crosslinking agent is present in said binder composition in an amount from about 50 to about 85% by weight solids.

8. The fibrous insulation product of claim 1, wherein said acid/aldehyde scavenger is present in said binder composition in an amount from about 0.5 to about 15% by weight total solids.

9. The fibrous insulation product of claim 1, wherein said product is a ceiling board or ceiling tile.

10. The fibrous insulation product of claim 1, wherein said product has a density between about 2.0 and about 10 pcf.

11. A fibrous insulation product comprising:
a nonwoven fiber mat comprising a plurality of fibers bound together by an aqueous binder composition comprising:
a thermally degradable polyol;
a crosslinking agent; and
an organic or inorganic base selected from the group consisting of ammonia, alkyl-substituted amines, dimethyl amine, ethyl methyl amine, sodium hydroxide, potassium hydroxide, sodium carbonate, and t-butylammonium hydroxide, wherein said binder composition is free of added formaldehyde.

12. The fibrous insulation product of claim 11, wherein said crosslinking agent comprises a homopolymer of copolymer of acrylic acid.

13. The fibrous insulation product of claim 11, wherein said thermally degradable polyol is selected from the group consisting of polyvinyl alcohol and polyvinyl acetate.

14. The fibrous insulation product of claim 13, wherein said thermally degradable polyol is present in said binder composition in an amount from about 3.0 to 30.0% by weight solids.

15. The fibrous insulation product of claim 11, wherein said aqueous binder composition further includes one or more of a short-chain polyol with a molecular weight less than 1000 Daltons and carbohydrate-based polyol.

16. The fibrous insulation product of claim 15, wherein said carbohydrate-based polyol comprises a sugar alcohol selected from the group consisting of glycerol, erythritol, arabitol, xylitol, sorbitol, maltitol, mannitol, iditol, isomaltitol, lactitol, cellobitol, palatinitol, maltotritol, isosorbide, syrups thereof, and mixtures thereof.

17. The fibrous insulation product of claim 11, wherein said crosslinking agent is present in said binder composition in an amount from about 50 to about 85% by weight solids.

18. The fibrous insulation product of claim 11, wherein said base is present in said binder composition in an amount from about 0.5 to about 15% by weight total solids.

19. The fibrous insulation product of claim 11, wherein the pH of the binder composition is from about 2.7 to about 4.7.

20. The fibrous insulation product of claim 11, wherein said product is a ceiling board or ceiling tile.

21. A ceiling board comprising:
a nonwoven fiber mat having a first side and a second side, opposite said first side, said non-woven mat comprising a plurality of fibers bound together by at least partially cured aqueous binder composition comprising:
a thermally degradable polyol; and
a crosslinking agent, wherein at least one of said first side and second side of the nonwoven mat is at least partially coated with an acid/aldehyde scavenger selected from the group consisting of alkali hydroxides; alkaline earth hydroxides; alkali carbonates and alkali bicarbonates; ammonium and/or alkali phosphates; mono-, di-, and poly-primary amines; secondary or tertiary amines; aromatic amines; amides and lactams; and sulfites.

22. The ceiling board of claim 21, wherein the acid/aldehyde scavenger is in the form of a dry powder.

23. The ceiling board of claim 21, wherein the acid/aldehyde scavenger is added in an amount up to about 2.0 wt. % solids, based on weight of the ceiling board.

24. A ceiling tile comprising
a core comprising a nonwoven fiber mat having a first side and a second side, opposite said first side, the nonwoven fiber comprising a plurality of fibers bound together by a formaldehyde-free binder composition; and
at least one facer adhered to one of said first side and said second side, the facer being white or lightly colored, wherein said formaldehyde-free binder composition comprises:
a thermally degradable polyol;
a crosslinking agent; and
an acid scavenger selected from the group consisting of alkali hydroxides; alkaline earth hydroxides; alkali carbonates and alkali bicarbonates; ammonium and/or alkali phosphates; mono-, di-, and poly-primary amines; secondary or tertiary amines; aromatic amines; amides and lactams; and sulfites.

25. The ceiling tile of claim 24, wherein said ceiling tile, when exposed to heat, moisture, or aging experiences a 4b* shift of less than 1, as measured using the L*a*b* coordinate system using the CIELAB method.

26. The ceiling tile of claim 24, wherein said core comprises a density between about 2 and about 10 pcf.

27. A method for reducing discoloration of ceiling tiles, comprising:
producing a fiberglass insulation board having a first side and a second side, opposite said first side, the fiberglass insulation board comprising a plurality of glass fibers bound together by an aqueous binder composition;
at least partially curing said fiberglass insulation board; and
adhering a facer to at least one of said first side and said second side, wherein said formaldehyde-free binder composition comprises:
a thermally degradable polyol;
a crosslinking agent; and
an acid scavenger selected from the group consisting of alkali hydroxides; alkaline earth hydroxides; alkali carbonates and alkali bicarbonates; ammonium and/or alkali phosphates; mono-, di-, and poly-primary amines; secondary or tertiary amines; aromatic amines; amides and lactams; and sulfites.
